(19) United States
(12) Patent Application Publication
(10) Pub. No.: US 2018/0327228 A1
(43) Pub. Date: Nov. 15, 2018

(54) TENSIONING ARRANGEMENT FOR AN ELEVATOR

(71) Applicant: Kone Corporation, Helsinki (FI)

(72) Inventors: Matti Rasanen, Helsinki (FI); Markku Haapaniemi, Helsinki (FI); Janne Mikkonen, Helsinki (FI); Jorma Mustalahti, Hyvinkaa (FI); Esko Aulanko, Helsinki (FI)

(73) Assignee: Kone Corporation, Helsinki (FI)

(21) Appl. No.: 16/043,793

(22) Filed: Jul. 24, 2018

Related U.S. Application Data
(63) Continuation of application No. PCT/FI2016/050034, filed on Jan. 25, 2016.

(51) Int. Cl. B66B 11/00; B66B 9/00; B66B 7/06; B66B 5/00

(52) U.S. Cl. CPC B66B 11/009; B66B 9/00; B66B 5/00; B66B 7/068; B66B 11/0045

(57) ABSTRACT

The invention relates to a tension arrangement for an elevator, which elevator comprises at least an elevator car arranged to run in an elevator shaft along guide rails, a counterweight or balance weight connected to the elevator car with a traction member from below and suspension ropes from above, and a hoisting machinery equipped with a drive wheel and an elevator motor in the lower part of the elevator shaft. The drive wheel and elevator motor are supported by a lever mechanism which is arranged to allow the drive wheel and elevator motor to move up and down.

This application is a continuation of PCT International Application No. PCT/FI2016/050034 which has an International filing date of Jan. 25, 2016, the entire contents of which are incorporated herein by reference.

The present invention relates to a tension arrangement for an elevator as defined in the preamble of claim 1.

The present invention relates mainly elevators where the suspension and moving of the elevator car are separated from each other. In these solutions the elevator car and counterweight or balance weight are suspended by a suspension element that can be, for instance, a group of parallel ropes or belts or one strong belt only. Whereas the elevator car is moved up and down by one or more traction members that are fastened between the elevator car and counterweight or balance weight. In that case the traction member can be, for instance, a toothed belt.

A problem with elevators mentioned above is the tensioning of the elevator system including the suspension element and the traction member of members. The tensioning of the ropes and/or the belts must be sufficient but not too strong. And different kind of tensioning is needed during the run of the elevator car and during the loading and unloading of the elevator car. In addition the slackening of the traction member must be continuously monitored. One possibility according to prior art technology is to use a pretension to keep the traction member sufficiently tight also in high buildings. However, a problem in that case is high tensions in the ropes and/or belts.

One object of the present invention is to eliminate drawbacks of prior art technology and to achieve a tensioning arrangement for an elevator, which arrangement contains an active tensioning system that can be used also in high-rise buildings during the run of the elevator car and during the loading and unloading of the elevator car. Another object of the present invention is to achieve a simple, cost effective and compact tensioning arrangement for an elevator, in which arrangement the own mass of the elevator motor can be utilized for tensioning the system, and which tensioning arrangement works always actively. Yet another object of the present invention is to achieve a tensioning arrangement that does not cause additional tension in the system after emergency stops. And yet another object of the present invention is to achieve a tensioning arrangement that decreases spring effects in high-rise elevators and thus makes big hoisting heights possible. And, in addition, yet another object the invention is to achieve a standardized waterproof machinery unit, which is easy to install and can be used in various kinds of elevators without making modifications. The arrangement according to the invention is characterized by what is disclosed in the characterization part of claim 1. Other embodiments of the invention are characterized by what is disclosed in the other claims.

Preferably the invention is expressed as a tensioning arrangement for an elevator, which elevator comprises at least an elevator car arranged to run in an elevator shaft along guide rails, a counterweight or balance weight connected to the elevator car with a traction member from below and suspension ropes from above, and a hoisting machinery equipped with a drive wheel and an elevator motor in the lower part of the elevator shaft. According to the invention the drive wheel and elevator motor are supported by a lever mechanism which is arranged to allow the drive wheel and elevator motor to move up and down. The suspension of the motor and the drive wheel driven by the motor could by supported by the lever mechanism to tighten the traction member utilizing only the weight of the motor and drive wheel and possibly further components adjoined to the motor. Alternately, in addition to the weight of the motor and drive wheel and possibly further components adjoined to the motor, also a force member or power device could be arranged to contribute to the tightening of the traction member.

Advantageously the hoisting machinery is fitted inside a waterproof casing already at the factory to form an integrated standardized machinery unit that is transported to the installation site and installed at the bottom part of the elevator shaft.

The invention makes it possible to achieve an active tensioning system for an elevator in a simple and cost effective way. In addition the standardized machinery unit is easy to install in many kinds of elevators without making modifications at the installation site. The arrangement according to the invention also protects the hoisting machinery from water and other things, such as dust although the machinery is installed at the bottom of the elevator shaft.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

One advantage of the arrangement according to the invention is a simple, cost effective and compact structure of the tensioning arrangement. The lever mechanism supports the motor and drive wheel to float so that they move up and down as their weight maintain the tension of the traction member. Another advantage is that the own mass of the elevator motor is utilized in the tensioning arrangement so that the tensioning is always active and does not cause additional tension to the system, for example after emergency stops. Yet another advantage is that the arrangement is a simple and cost effective way to increase the hoisting height of the elevator, for example in high-rise elevators. Also one advantage is that the number of monitoring means can be reduced. Yet a further advantage is that the hoisting machinery unit can always be similar in many kinds of elevators without any modifications to be made or requiring only minor modifications. Yet a further advantage is that the hoisting machinery unit is placed inside a protective casing that protects the hoisting machinery from water, for example in case of a flood, and from dust, dirt and other debris, and also from other fluids than water. Above-mentioned advantages lead to yet another advantage that the machinery can be normally located at the bottom of the elevator shaft so that it does not take unnecessary space elsewhere in the elevator shaft. Yet another advantage is that the casing belonging to the arrangement can be used also as a transport means to bring the machinery to the location of the elevator. Yet another advantage is that the casing reduces the noise level of the machinery.

In the following, the invention will be described in detail by the aid of example embodiments by referring to the attached drawings, wherein

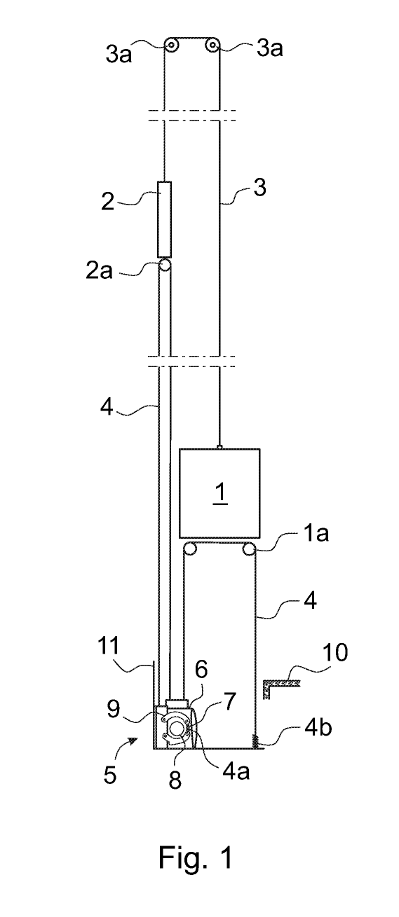

FIG. 1 presents in a simplified and diagrammatic side view an elevator, in which the arrangement according to the invention can be used,

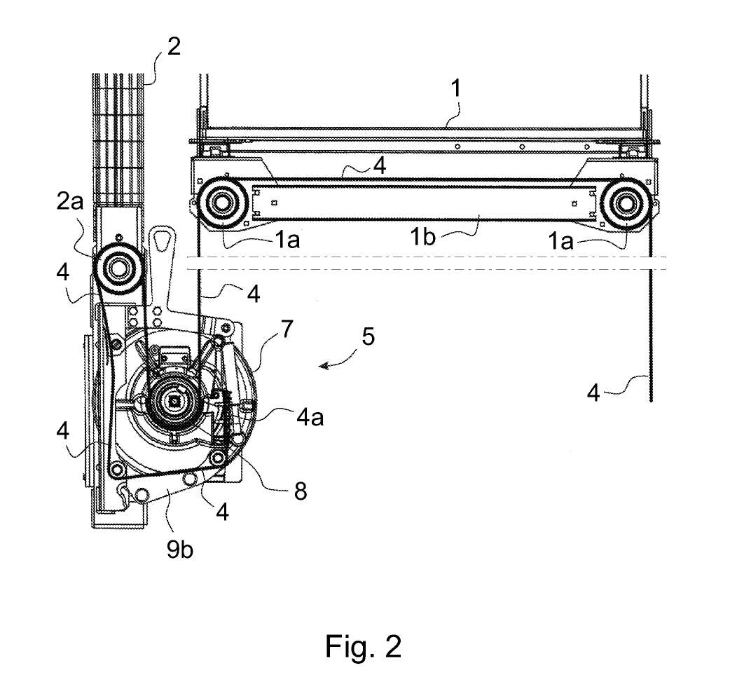

FIG. 2 presents in a simplified and diagrammatic side view a partially cross-sectioned hoisting machinery of an elevator located at the bottom part of the elevator shaft under a balance weight and an elevator car, and which hoisting machinery is used in the arrangement according to the invention,

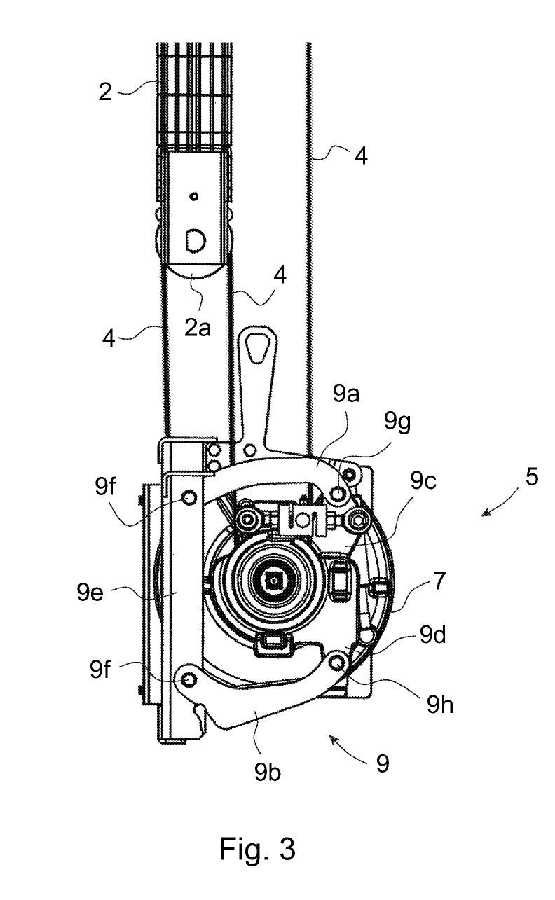

FIG. 3 presents in a simplified and diagrammatic side view the hoisting machinery according to FIG. 2 cross-sectioned in a different way than in FIG. 2,

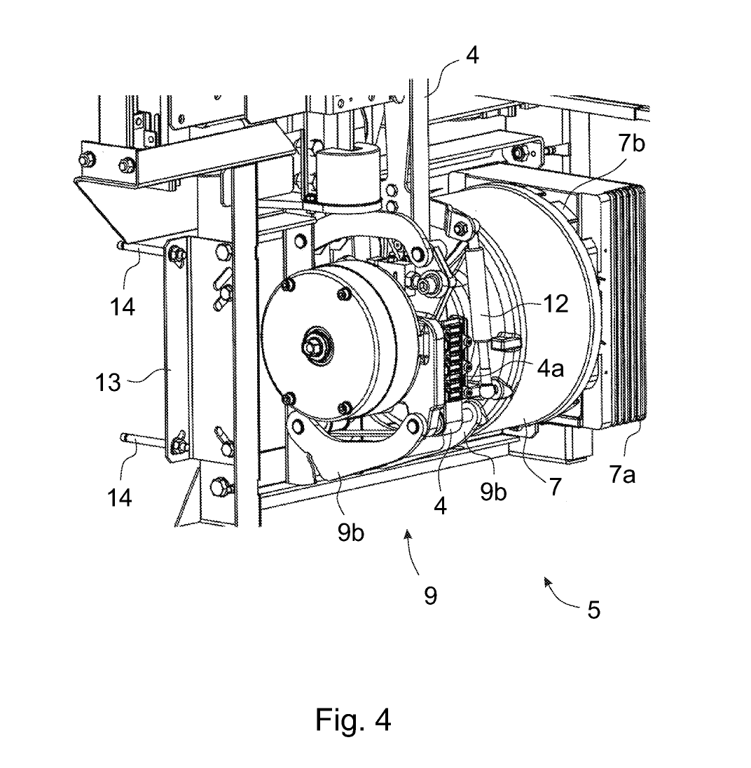

FIG. 4 presents in a simplified and diagrammatic oblique top and side view a hoisting machinery used in the arrangement according to the invention, and

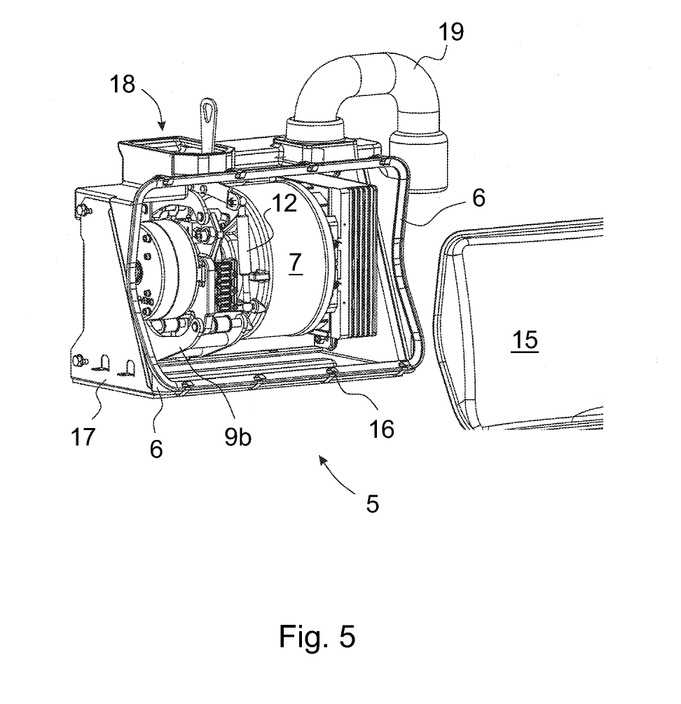

FIG. 5 presents in a simplified and diagrammatic oblique top and side view the hoisting machinery according to FIG. 4 equipped with a casing in a situation when the cover of the casing is open.

The main idea of the invention is to arrange an active tensioning of the elevator system using the own mass of the elevator hoisting motor that is supported by a lever mechanism that allows the elevator hoisting motor to move up and down suspended at least partially by a traction member of the elevator.

FIG. 1 presents in a simplified and diagrammatic side view an elevator, in which the arrangement according to the invention is used. The elevator comprises among other things an elevator car 1 that is arranged to run up and down in the elevator shaft along substantially vertical guide rails, and a counterweight or balance weight 2 that is also arranged to run up and down in the elevator shaft along its guide rails. The guide rails of the elevator car 1 and balance weight 2 are not presented in FIG. 1 for the sake of clarity. Later in this connection only balance weight 2 is mentioned when either counterweight or balance weight is meant.

The supporting and moving of the elevator car 1 are separated from each other. The elevator car 1 is driven by a hoisting machinery 5 equipped with a drive wheel 8. The hoisting machinery 5 is fitted inside a casing 6 at the bottom part of the elevator shaft, below the elevator car 1 and below the first floor level 10. The hoisting machinery 5 is fastened for instance on a wall 11 of the elevator shaft near the bottom of the elevator shaft.

A traction member 4 is connected between the balance weight 2 and the elevator car 1. The traction member 4 can be a single member or a bunch of similar parallel members, for instance, the traction member 4 can be a toothed belt, chain or other type of member that does not slip on the drive wheel 8. Advantageously the suspension ratio of the traction member 4 is 2:1. In that case the first end of the traction member 4 is secured at the first fastening point 4a in connection with the hoisting machinery 5 from where the traction member 4 is led upwards to go over and around a diverting pulley 2a that is fitted with bearings on its shaft at a lower end of the balance weight 2.

From the diverting pulley 2a the traction member 4 is guided down to the elevator hoisting machinery 5 and to go under and around the drive wheel 8 and then again up to the elevator car 1 where the traction member 4 is guided over and around diverting pulleys 1a, after which the traction member 4 is led down to the second fastening point 4b of the second end of the traction member 4. The second fastening point 4b can be, for instance, at the bottom of the elevator shaft.

The elevator car 1 is suspended by suspension element 3 that is connected between the balance weight 2 and the elevator car 1. The suspension element 3 can be a single member or a bunch of similar parallel members, for instance suspension ropes. The first ends of the suspension element 3 is secured to the upper part of the balance weight 2 and from the balance weight 2 the suspension element 3 is led upwards to go over and around diverting pulleys 3a that are fitted with bearings on their shafts, for instance at a support beam which is fastened, for example, to the upper part of the guide rails above the elevator car 1. From the diverting pulleys 3a the suspension element 3 descends to the elevator car 1 where the second end of the suspension element 3 is secured to the upper part of the elevator car 1.

The elevator motor 7 together with the drive wheel 8 is suspended by a lever mechanism 9 that belongs to the hoisting machinery 5 and allows the elevator motor 7 and drive wheel 8 to move substantially freely up and down in certain limits. The suspension of the elevator motor 7 and drive wheel 8 can be called a floating suspension. The lever mechanism 9 is presented only schematically in FIG. 1.

FIG. 2 presents the hoisting machinery 5 partially cross-sectioned and installed at its place at the bottom part of the elevator shaft substantially under the balance weight 2 and below the elevator car 1. In the situation of FIG. 2 the balance weight 2 is in its lowermost position and the elevator car 1 is in its uppermost position though it is also seen in the FIG. 2.

As mentioned already above the traction member 4 is guided from the first fastening point 4a of the traction member 4 under and around diverting pulleys 4c underneath the drive wheel 8 and then upwards and around the diverting pulley 2a, further downwards and around the drive wheel 8, then upwards and around the diverting pulleys 1a in the elevator car 1, after which the traction member 4 is led down to the second fastening point 4b of the traction member 4. Likewise the elevator motor 7 and the drive wheel 8 the first fastening point 4a is suspended floating by the lever mechanism 9 that allows also the first fastening point 4a to move up and down in certain limits caused by the own mass of the elevator motor 7 and the drive wheel 8.

FIG. 3 presents the hoisting machinery 5 according to FIG. 2 cross-sectioned in a different way than in FIG. 2, so that the floating suspension of the elevator motor 7 and drive wheel 8 by the lever mechanism 9 is better seen. The lever mechanism 9 comprises at least a substantially vertical support element 9e, an upper lever arm 9a, a lower lever arm 9b, an upper frame part 9c and a lower frame part 9d. Preferably the upper frame part 9c and the lower frame part 9d have been connected together as one solid unit. The support element 9e is fastened to the frame of the elevator machinery 5.

The first ends of the lever arms 9a, 9b are connected to the support element 9e with joint pins 9f so that the lever arms 9a, 9b can pivot in relation to the support element 9e. Correspondingly the second end of the upper lever arm 9a is pivoted to the upper frame part 9c with a joint pin 9g and the second end of the lower lever arm 9b is pivoted to the lower frame part 9d with a joint pin 9h. The frame parts 9c, 9d and the lever arms 9a, 9b and their mutual geometry are arranged to suspend the elevator motor 7 and drive wheel 8 in a floating way so that the elevator motor 7 and drive wheel 8 can move substantially freely up and down in certain limits, and at the same time keep the traction member 4 and the whole elevator system tensioned suitably tight.

FIG. 4 presents the hoisting machinery 5 in an oblique top and side view at its operation place without the casing 6. The hoisting machinery 5 is fastened for example onto the wall 11 of the elevator shaft near the bottom of the shaft. The fastening is made for example with fastening plates 13 and fastening bolts 14 on both end sides of the hoisting machinery 5. The hoisting machinery 5 also comprises a drive 7a and a fan 7b between the drive 7a and the hoisting motor 7. The fan 7b is arranged to take care of ventilation of the hoisting machinery 5 when the hoisting machinery 5 is inside the casing 6.

As seen in FIG. 4 the lever mechanism 9 according to the embodiment of the example comprises for instance one upper lever arm 9a and two parallel lower lever arms 9b with a distance from each other. The parallel lower lever arms 9b are connected to each other with the joint pins 9f and 9h.

The lever mechanism 9 is arranged to support the elevator motor 7 and the drive wheel 8 and other parts of the hoisting machinery 5 so that the joint pin 9h at the outer or second end of the lever arms 9b is fastened at its second end to the casing of the elevator motor 7 and the combination of the frame parts 9c, 9d is fitted, for example with bearings on the shaft of the elevator motor 7.

The hoisting machinery 5 also comprises an auxiliary power device 12 such as a gas spring to produce additional force for the tensioning of the elevator system. This kind of auxiliary power device 12 is needed particularly in big elevators, for instance in high-rise buildings, if the own mass of the elevator motor 7 is not sufficient. Instead of gas springs other auxiliary power devices can also be used, such as linear actuators, gear motors, hydraulic actuators or air-driven actuators. The auxiliary power device 12 is connected to the tension control system and is arranged, for instance, between the frame of the hoisting machinery 5 and the elevator motor 7 to press the elevator motor 7 downwards when needed. A power source of the auxiliary power device 12 is, for example, an electrically controlled solenoid.

In high-rise elevators big spring effects may cause problems particularly during loading and unloading situations when using the active tensioning system where at least the own mass of the elevator motor 7 is used as a tensioning force. To avoid that problem and to make bigger hoisting heights possible the arrangement according to invention also comprises auxiliary locking mechanism to switch the active tensioning system temporarily off by locking vertical position of the elevator motor 7 and drive wheel 8. This kind of a locking arrangement decreases considerably the spring effect in big hoisting heights. The locking mechanism is connected to the elevator control system and comprises, for instance a locking means, such as a dowel-hole system or alike, and a power source, for example the electrically controlled solenoid of the gas spring that acts as the auxiliary power device 12, or an electric motor, a hydraulic actuator or also a brake.

As shown in FIG. 5 the hoisting machinery 5 is preferably fitted inside the casing 6. The hoisting machinery 5 and the casing 6 together form an integrated machinery unit, or only a machinery unit. The machinery unit is assembled at a factory and after that transported to its destination and installed to the bottom part of the elevator shaft as one unit. The hoisting machinery 5 and its casing 6 is installed inside a frame structure 17 and secured, for example, to the wall 11 or walls of the elevator shaft with help of securing means 13, 14, which in this case comprise for example brackets, bolts and nuts.

The casing 6 comprises a detachable cover 15. The cover 15 is arranged to close the casing 6 so that the casing 6 is waterproof. The casing 6 and the cover 15 can be made of the same material or the materials can also be different from each other. For example, the casing 6 can be made of plastic and the cover 15 of some metal, such as steel or aluminum. In such a case, the cover 15 acts also as a cooling element. In this embodiment the cover 15 is arranged to be attached to the casing 6 with help of clips 16.

At the upper part of the casing 6 there is an opening 18 for the traction member 4 to enter the casing 6 and to exit the casing 6 when the traction member makes 4 its turn around the drive wheel 8 inside the casing 6. The arrangement also comprises a cover means in connection with the opening 18 to prevent water from entering the casing 6, for example in case of a flood when water may enter the elevator shaft. The cover means could be for instance a bellows-like cover or a corresponding means, which is arranged to rise along with water if the water surface level rises above the opening 18.

Also a ventilation pipe 19 belongs to the casing 6. The ventilation pipe 19 can, for instance, be shaped substantially like a downwardly opening semicircle or alike where its first end starts upwards from the upper part of the casing 6 and the second end points freely downwards. Inside the casing 6 there is also the fan 7b that is arranged to take care of ventilation of the hoisting machinery 5 through the ventilation pipe 19.

It is obvious to the person skilled in the art that the invention is not restricted to the examples described above but that it may be varied within the scope of the claims presented below. Thus, for instance, the elevator can also be different from the elevator described above. For example the suspension ratio of the elevator can be different.

It is also obvious to the person skilled in the art that the mounting of the machinery unit can also be done in a different way. For example, the machinery unit can also be secured to the floor of the elevator shaft instead of a wall or walls of the elevator shaft, or the machinery unit can be secured to both, the floor and wall or walls.

It is further obvious to the person skilled in the art that the protection means, which prevents water entering the casing through the opening can be different from what is presented above. For example, some other kind of protection means can be used, which protection means are triggered to close the opening when enough water enters the bottom of the elevator shaft. In that case protection means comprises, for example means, which are arranged to be inflated with air and seal the opening when the water surface reaches predefined level at the bottom of the elevator shaft.

1. Tension arrangement for an elevator, which elevator comprises at least an elevator car arranged to run in an elevator shaft along guide rails, a counterweight or balance weight connected to the elevator car with a traction member from below and suspension element from above, and a hoisting machinery equipped with a drive wheel arranged to drive the traction member and an elevator motor in the lower part of the elevator shaft, wherein the drive wheel and elevator motor are supported by a lever mechanism which is arranged to allow the drive wheel and elevator motor to move up and down.

2. Tension arrangement according to claim 1, wherein the traction member is arranged to suspend the drive wheel and elevator motor, and the own mass of the drive wheel and elevator motor is arranged to form an active tensioning system in order to tension the elevator system in its own part.

3. Tension arrangement according to claim 1, wherein the arrangement comprises an auxiliary power device that is arranged to produce additional force for the tensioning of the elevator system.

4. Tension arrangement according to claim 3, wherein the auxiliary power device is one or more of the following: a gas spring, a linear actuator, a gear motor, a hydraulic actuator, an air-driven actuator or another suitable actuator.

5. Tension arrangement according to claim 4, wherein the auxiliary power device is connected to the tension control system of the elevator, and arranged between the frame of the hoisting machinery and the elevator motor to press the elevator motor downwards when needed.

6. Tension arrangement according to claim 1, wherein the arrangement comprises an auxiliary locking mechanism to switch the active tensioning system temporarily off by locking the vertical position of the elevator motor and drive wheel.

7. Tension arrangement according to claim 6, wherein the auxiliary locking mechanism is connected to the elevator control system and comprises a locking means that is arranged to lock the elevator motor and drive wheel in a certain vertical position in the hoisting machinery.

8. Tension arrangement according to claim 6, wherein the locking means is one or more of the following: a dowel-hole system or alike, a power source, for example the electrically controlled solenoid of the gas spring that acts as the auxiliary power device, an electric motor, a hydraulic actuator or a brake or another suitable actuator.

9. Tension arrangement according to claim 1, wherein the hoisting machinery is fitted inside a waterproof casing and the hoisting machinery and the casing together form a machinery unit.

10. Tension arrangement according to claim 9, wherein the casing comprises an opening at its upper part, through which opening the traction member is arranged to enter and exit the casing.

11. Tension arrangement according to claim 9, wherein the casing is equipped with protection means to prevent water from entering the casing through the opening.

12. Tension arrangement according to claim 11, wherein the protection means comprises at least one of the following: a floating part and a bellows part where the floating part is arranged to move along water surface level moving also the bellows part with itself, or means which are arranged to be inflated with air and seal the opening when the water surface reaches predefined level at the bottom of the elevator shaft.

13. Tension arrangement according to claim 1, wherein the casing is equipped with a ventilation pipe.

14. Tension arrangement according to claim 13, wherein the hoisting machinery is equipped with a fan, which is arranged to take care of ventilation of the hoisting machinery at least through the ventilation pipe.
